(19) United States
(12) Patent Application Publication
(10) Pub. No.: US 2019/0338709 A1
(43) Pub. Date: Nov. 7, 2019

(54) AUXILIARY SYSTEM FOR DRIVING A SHAFT OF A HELICOPTER PROPULSION SYSTEM

(71) Applicant: SAFRAN HELICOPTER ENGINES, Bordes (FR)

(72) Inventors: Romain THIRIET, Moissy-Cramayel (FR); Camel SERGHINE, Moissy-Cramayel (FR); Guillaume DEMEZON, Moissy-Cramayel (FR)

(21) Appl. No.: 16/096,642

(22) PCT Filed: Apr. 24, 2017
(86) PCT No.: PCT/FR2017/050974

§ 371 Date: Oct. 25, 2018

(30) Foreign Application Priority Data
Apr. 28, 2016 (FR) 1653789

(51) Int. Cl. F02C 7/36; F02C 3/10

(52) U.S. Cl. CPC F02C 7/36; B64C 27/06; F02C 3/10

(57) ABSTRACT

The invention relates to an auxiliary system for mechanically driving a relay shaft (8) of a helicopter propulsion system, comprising: a hydraulic motor (7), mechanically connected to said relay shaft (8); a hydraulic circuit (10) for supplying a pressurised liquid to said hydraulic motor(7) a controlled, fast-opening hydraulic valve (11) arranged on the hydraulic circuit (10); a pyro-hydraulic storage unit (9) driven by a control unit (12) and connected to said hydraulic valve (11), said pyro-hydraulic storage unit (9)comprising: an enclosure (20) including a piston (16) that defines a main compartment (17) having at least one solid propellant cartridge (19) and a compartment (18) for a liquid supply; an ignition charge (25) connected to said main compartment (17) and suitable for initiating the combustion of at least one solid propellant cartridge (19) upon receiving a command from said control unit (12).

### 1. TECHNICAL FIELD OF THE INVENTION

The invention concerns an auxiliary system for driving a shaft of a helicopter propulsion system. Such an auxiliary system is, for example, intended to occasionally provide mechanical power to reactivate a turboshaft engine in standby, or to assist an autorotation operation of a single-engine helicopter or to ensure an additional occasional propulsion power or to assist a multi-engines helicopter whose one engine is not operational (situation known under the acronym OEI for One Engine Inoperative). The invention also concerns a helicopter equipped with such an auxiliary mechanical drive system.

### 2. TECHNOLOGICAL BACKGROUND

There are numerous situations during a flight of a helicopter (single-engine or multi-engines) where an occasional mechanical power proves to be necessary to secure the flight.

For example, it has already been proposed by the applicant in the application FR3019588 a device for mechanically assisting a single-engine helicopter propulsion system allowing to provide occasionally, from a solid propellant gas generator, a propulsive power directly to the rotor of the helicopter during a flight in autorotation. Such a solution allows, therefore, to overcome a failure of the turboshaft engine by supplying a supplemental mechanical power to the helicopter, allowing to make the autorotation manoeuvre reliable in case of a failure of the turboshaft engine.

This solution seems promising, but requires an important quantity of propellant embedded in the engine zone. Furthermore, the pyrotechnical system not being closed, it contributes to the emission of gas ejected outside of the system. This important quantity of propellant can pose difficulties, especially concerning transport regulations.

It has also been proposed by the applicant in the application FR3019221 a hydraulic device for an emergency start of a turboshaft engine allowing to provide, by means of hydraulic means, a mechanical power for starting a turboshaft engine.

This solution is promising, but the bulk of the system could pose a few problems for being integrated in some helicopters.

The inventors have therefore sought to propose a solution allowing to occasionally provide a mechanical power to at least one shaft of a helicopter propulsion system, this shaft being a power transmission box shaft, or a turboshaft engine shaft, and generally, any shaft connected directly or indirectly to the rotor of the helicopter.

The inventors have, in particular, sought to propose a new solution to occasionally provide a mechanical power to a helicopter propulsion system which meets the lightness and small bulk criteria.

### 3. AIMS OF THE INVENTION

The invention aims to provide an auxiliary system for driving in rotation a shaft of a helicopter propulsion system.

The invention also aims to provide, in at least one embodiment, an auxiliary system for driving in rotation a shaft of a helicopter propulsion system which is not very bulky.

The invention also aims to provide, in at least one embodiment, an auxiliary system for driving in rotation a shaft of a helicopter propulsion system which is light.

The invention also aims to provide, in at least one embodiment, an auxiliary system for driving in rotation a shaft of a helicopter propulsion system which can be certified for different types of helicopter (single-engine, two-engines, three-engines especially) and to overcome different mechanical failures.

The invention also aims to provide, in at least one embodiment, an auxiliary system for driving in rotation a shaft of a helicopter propulsion system which can be produced at costs compatible with profitability and cost optimisation aims. The invention also aims to provide a helicopter equipped with an auxiliary system according to the invention.

### 4. DESCRIPTION OF THE INVENTION

To do this, the invention relates to an auxiliary system for driving in rotation a shaft, called relay shaft, of a helicopter propulsion system comprising at least one turboshaft engine connected to a power transmission box adapted to drive in rotation a rotor of the helicopter, said system comprising:

a hydraulic motor mechanically connected to said relay shaft and adapted to be able to drive it in rotation,

a hydraulic circuit for supplying a pressurised liquid to said hydraulic motor,

a controlled, fast-opening hydraulic valve arranged on the hydraulic circuit and adapted to be placed on command at least in one open position wherein the liquid can supply said hydraulic motor to enable a driving in rotation of said relay shaft, or in a closed position wherein said hydraulic motor is no longer supplied with pressurised liquid.

An auxiliary system according to the invention is characterised in that said system further comprises a pyro-hydraulic storage unit driven by a control unit and connected to said hydraulic valve of said hydraulic circuit by a liquid supply line, said pyro-hydraulic storage unit comprising:

an enclosure comprising a piston that defines two sealed compartments, a main compartment comprising at least one solid propellant cartridge, and a compartment for a liquid reserve opening into said liquid supply line,

an ignition charge connected to said main compartment and adapted to initiate the combustion of at least one solid propellant cartridge upon receiving a command from said control unit.

A system according to the invention therefore comprises a pyro-hydraulic storage unit whose hydraulic part is preferably completely independent of the hydraulic network of the helicopter which allows to pressurise a liquid of a hydraulic circuit connected to a hydraulic motor for driving in rotation a relay shaft of a helicopter propulsion system.

The pyro-hydraulic storage unit of the system according to the invention comprises a small gas generator which is formed by at least one solid propellant cartridge. Once ignited, the gas produced by the cartridge applies a pressure on the piston of the enclosure, which allows to pressurise the liquid of the liquid reserve. This liquid is expelled towards the hydraulic motor by means of the supply line of the hydraulic circuit and of the hydraulic circuit, which allows to drive in rotation the relay shaft mechanically connected to the hydraulic motor.

The supply in liquid of the hydraulic motor is achieved by the cooperation of the pyro-hydraulic storage unit and a controlled fast-opening valve.

The pyro-hydraulic storage unit of a system according to the invention combines the advantages of a pyrotechnical solution and the advantages of a hydraulic solution, without however having to support its disadvantages.

In particular, the system according to the invention benefits from both the energy density of a pyrotechnical solution (by means of the main compartment housing the solid propellant cartridges) and the power density of a hydraulic solution (by means of the liquid reserve of the second compartment).

A system according to the invention can be independent both of the electrical network of the helicopter and of the hydraulic network. In particular, no electrical energy storage battery is necessary. In addition, one or more solid propellant cartridges are sufficient for ensuring the rotation of the relay shaft. The proposed solution therefore allows to provide a supplementary mechanical power, without generating size, weight and cost problems.

The small size thereof enables the system to be integrated into an engine compartment.

Furthermore, a system according to the invention is simple to use and can be bench-tested before it is integrated on a helicopter.

A system according to the invention also allows to deliver a constant torque, which facilitates the integration thereof into an architecture of a helicopter.

A system according to the invention does not present permanently pressurised elements. In addition, once the charge is ignited and the system is activated, the released gas remains confined in a closed volume, which facilitates the transport classification, the implementation and the certification of the object.

Advantageously and according to the invention, said main compartment of said enclosure of said pyro-hydraulic storage unit comprises at least two solid propellant cartridges.

According to this variant, at least two solid propellant cartridges are used in the main compartment to generate more pressure during the activation of the ignition charge. This allows, for example, to drive the relay shafts requiring a significant starting torque.

Advantageously and according to the invention, said enclosure comprises a sealed membrane arranged between the solid propellant cartridges and said piston.

This sealed membrane aims to guarantee sealing between the two compartments of the enclosure.

Advantageously and according to the invention, said piston is a differential section piston configured to be able to compress the liquid of said compartment of liquid reserve at a pressure different from the pressure of the gas of the main compartment.

According to this variant, the pressure given to the liquid of the liquid reserve is different from the pressure of the gas released by the ignition of the solid propellant cartridge. This allows to adapt the torque delivered to the relay shaft.

Advantageously, a system according to the invention comprises a tarpaulin for liquid recovery connected to said hydraulic motor by means of a drainage valve.

The assembly formed by the recovery tarpaulin and the drainage valve allows for an expulsion of the liquid from the hydraulic circuit as soon as the pressure of the liquid in this circuit exceeds a predetermined threshold, and a recovery of this liquid expelled into the recovery tarpaulin. The drainage valve defines the predetermined threshold from which the liquid is expelled from the hydraulic circuit.

Advantageously, a system according to the invention comprises at least one freewheel carried by said relay shaft.

The presence of the freewheel allows to avoid a spontaneous driving of the hydraulic motor by the relay shaft.

According to a variant, the relay shaft carrying a freewheel is a shaft of an accessory box of a turboshaft engine.

An accessory box of a turboshaft engine allows to drive the constraints necessary for the functioning of the gas generator of the turboshaft engine and helicopter equipment, like for example, the air conditioning devices. According to this variant, the hydraulic motor is directly integrated on this accessory box, which allows, on the one hand, to facilitate the installation and interconnection thereof with the gas generator of the turboshaft engine, and on the other hand, to provide, if necessary, a part of the power necessary to drive the constraints and/or to supply the helicopter equipment.

Advantageously and according to the invention, said relay shaft is a shaft of said power transmission box such that the system can act as an assistance system for an autorotation of a single-engine helicopter.

According to this variant, the auxiliary system is used to provide mechanical power directly to the power transmission box when necessary. Such a system is therefore particularly adapted to mechanically assist the helicopter during a flight in autorotation, especially during the last phases of the flight.

The use of a system according to this variant therefore allows to make flights in autorotation of a helicopter reliable, and to therefore substantially improve the damage-free landing ratio, requiring a long period of immobilisation of the helicopter.

Advantageously and according to the invention, said relay shaft is a shaft of a turboshaft engine of the propulsion system so that the system can act as a reactivation system for reactivating this turboshaft engine.

According to this variant, the auxiliary system is intended to equip a multi-engines helicopter comprising turboshaft engines connected to a power transmission box, whose at least one turboshaft engine among said turboshaft engines, called hybrid turboshaft engine, is capable of functioning in at least one standby system during a stabilised flight of the helicopter, the other turboshaft engines functioning by themselves during this stabilised flight.

A hybrid turboshaft engine is a turboshaft engine configured to be able to be put, on command and voluntarily, in at least one predetermined standby system, from which it can exit normally or quickly (also called emergency). A turboshaft engine can only be on standby during a stabilised flight of the helicopter, i.e. outside a failure of a turboshaft engine of the helicopter, during a cruise flight situation, when it evolves under normal conditions. Exiting the standby system consists of passing the turboshaft engine in acceleration mode of the gas generator by a drive compatible with the exit mode imposed by the conditions (normal standby exit or quick standby exit (also called emergency)).

The auxiliary system according to the invention thus allows to ensure the quick reactivation of the turboshaft engine into standby if needed.

The invention also concerns a helicopter comprising a propulsion system, characterised in that it further comprises an auxiliary system for mechanically driving a shaft of said propulsion system according to the invention.

The invention also relates to an auxiliary system and a helicopter equipped with such a system, characterised in combination by all or some of the characteristics mentioned above or below.

### 5. LIST OF FIGURES

Other aims, characteristics and advantages of the invention will appear upon reading the following description given only in a non-limiting manner, and which refers to the appended figures, wherein:

FIG. 1 is a schematic view of an auxiliary system according to an embodiment of the invention used as a device for quickly reactivating a turboshaft engine,

FIG. 2 is a schematic view of a pyro-hydraulic storage unit of a system according to another embodiment of the invention,

FIG. 3 is a schematic view of a piston of a pyro-hydraulic storage unit of a system according to another embodiment of the invention.

### 6. DETAILED DESCRIPTION OF AN EMBODIMENT OF THE INVENTION

In the figures, the scales and proportions are not respected and this, for purposes of illustration and clarity.

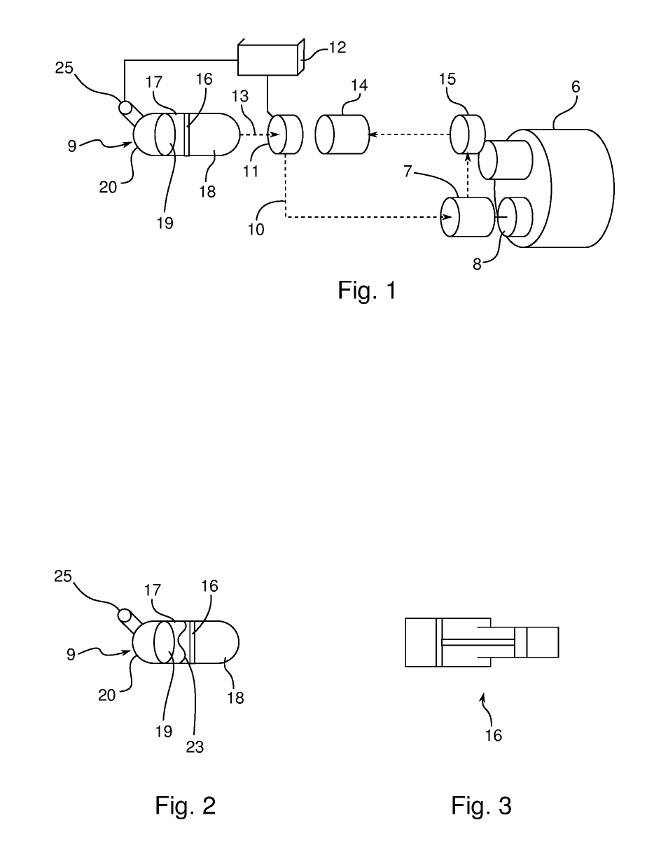

FIG. 1 is a schematic view of an auxiliary system for driving in rotation a relay shaft 8 according to the invention formed by a shaft of a turboshaft engine 6.

The auxiliary system according to this embodiment is therefore destined to be able to ensure the quick reactivation of the turboshaft engine 6.

The system according to the embodiment of FIG. 1 comprises a hydraulic motor 7 mechanically connected to the turboshaft engine 6 by means of a freewheel. This hydraulic motor 7 can be a motor with axial or radial pistons. It has the function of transforming the hydraulic power it receives in a mechanical power allowing to drive the starting or the reactivation of the turboshaft engine 6.

This hydraulic motor 7 is preferably mounted on the turboshaft engine 6 by means of an accessory box, not represented in FIG. 1.

The auxiliary system according to the invention also comprises a pyro-hydraulic storage unit 9 connected to the hydraulic motor 7 by means of a hydraulic circuit 10 for supplying a pressurised liquid to this hydraulic motor 7. This hydraulic circuit 10 is itself supplied with liquid by a supply line 13 which connects the hydraulic circuit 10 and the pyro-hydraulic storage unit 9.

The supply of the hydraulic motor 7 is dependent on a controlled, fast-opening hydraulic valve 11, which is arranged on the hydraulic circuit 10 between the storage unit 9 and the hydraulic motor 7.

This hydraulic valve 11 is controlled by a control device 12, which is preferably the control computer of the turboshaft engine 6, which further allows to define the operating regime of the turboshaft engine.

When the valve 11 is controlled in opening, the liquid expelled from the storage unit 9 is ejected towards the hydraulic motor 7 such that the latter transforms the hydraulic power of the liquid received into an exiting mechanical power.

The auxiliary system also comprises a tarpaulin 14 for liquid recovery connected to the hydraulic motor 7 by means of a drainage valve 15. This valve is tared such that the liquid is ejected from the circuit 10 as soon as the pressure exceeds a predetermined threshold.

The pyro-hydraulic storage unit 9 comprises, according to the embodiment of FIG. 1, an enclosure 20, a one-piece piston 16 housed in the enclosure and that defines two variable volume sealed compartments 17, 18. The compartment 17 houses a solid propellant cartridge 19 and the compartment 18 is a variable volume reserve of fluid. Hereinafter, it is considered that the liquid from the compartment 18 and from the hydraulic circuit is oil.

The storage unit 9 also comprises an ignition charge 25 adapted to initiate the combustion of the solid propellant cartridge 19 upon receiving a command from the control unit 12. Once ignited, the gas produced by the cartridge 19 disperses into the compartment 17 and applies a pressure on the piston 16 of the enclosure, which allows to pressurise the oil of the compartment 18 of the oil reserve. Oil is thus expelled towards the hydraulic motor 7 by means of the supply line 13 of the hydraulic circuit 10 and of the hydraulic circuit 10 as such.

A system according to the invention therefore allows for an occasional power input and can be used, either to reactivate a standby turboshaft engine, or to assist with an autorotation manoeuvre, or to ensure an additional instantaneous propulsion power, or to assist a helicopter which has lost the functioning of one of the engines thereof in the case of a two-engines or a three-engines helicopter, for example.

According to another embodiment, not represented in the figures, the pyro-hydraulic storage unit 9 comprises a plurality of solid propellant cartridges 19 housed in the compartment 17 of the enclosure 20.

In a variant or in a combination, and such as represented in FIG. 2, the storage unit can comprise a sealed membrane 23 arranged between the solid propellant cartridge 19 and the piston 16. The sealed membrane 23 aims to guarantee sealing between the two compartments of the enclosure. This membrane can be made from any type of sealed material.

In a complementary variant, the role of the piston can be held by a bladder which will ensure two major sought functions: movement of the volume and sealing between the two chambers.

According to another embodiment and such as represented in FIG. 3, the piston 16 is a differential section piston configured to be able to compress the liquid of the compartment for a liquid reserve at a pressure different from the pressure of the gas of the main compartment. This allows to adapt the torque delivered to the relay shaft.

The system described in relation to FIG. 1, is intended to be able to ensure the quick reactivation of a turboshaft engine. That being as such, the system according to the invention can be implemented to drive in rotation any shaft of a helicopter propulsion system, such as a shaft of a power transmission box of the helicopter, a shaft of an accessory box, a shaft of a gas generator of a turboshaft engine, or a shaft of a free turbine of a turboshaft engine. Generally, the system according to the invention can contribute to driving in rotation, on demand and when necessary, any type of shaft of a propulsion system. The person skilled in the art can easily apply the modifications necessary to the description above, in relation to a turboshaft engine to ensure the use of the system in the other applications covered by the invention.

1. Auxiliary system for mechanically driving a shaft, called relay shaft, of a helicopter propulsion system comprising at least one turboshaft engine connected to a power transmission box adapted to drive in rotation a rotor of the helicopter, said system comprising:
a hydraulic motor mechanically connected to said relay shaft and adapted to be able to drive it in rotation,
a hydraulic circuit for supplying a pressurised liquid to said hydraulic motor,
a controlled, fast-opening hydraulic valve arranged on the hydraulic circuit and adapted to be placed on command at least in one open position wherein the liquid can supply said hydraulic motor to enable a driving in rotation of said relay shaft, or in a closed position wherein said hydraulic motor is no longer supplied with pressurised liquid,
wherein said system further comprises a pyro-hydraulic storage unit driven by a control unit and connected to said hydraulic valve of said hydraulic circuit by a liquid supply line, said pyro-hydraulic storage unit comprising:
an enclosure comprising a piston that defines two sealed compartments, a main compartment comprising at least one solid propellant cartridge, and a compartment for a liquid reserve opening into said liquid supply line,
an ignition charge connected to said main compartment and adapted to initiate the combustion of at least one solid propellant cartridge upon receiving a command from said control unit.

2. The auxiliary system according to claim 1, wherein said main compartment of said enclosure of said pyro-hydraulic storage unit comprises at least two solid propellant cartridges.

3. The auxiliary system according to claim 1, wherein said enclosure comprises a sealed membrane arranged between the solid propellant cartridges and said piston.

4. The system according to claim 1, wherein said piston is a differential section piston configured to be able to compress the liquid from said compartment for a liquid reserve at a pressure different from the pressure of the gas of the main compartment.

5. The system according to claim 1, wherein it comprises a tarpaulin for liquid recovery connected to said hydraulic motor by means of a drainage valve.

6. The system according to claim 1, wherein it comprises at least one freewheel carried by said relay shaft.

7.-9. (canceled)

10. The system according to claim 1, wherein said relay shaft is a shaft of said power transmission box so that the system can act as an assistance system for an autorotation of a single-engine helicopter.

11. The system according to claim 1, wherein said relay shaft is a shaft of a turboshaft engine of the propulsion system so that the system can act as a reactivation system of this turboshaft engine.

12. Helicopter comprising a propulsion system, wherein it further comprises an auxiliary system according to claim 1 for mechanically driving the shaft of said propulsion system.
